(19) United States
(12) Patent Application Publication
(10) Pub. No.: US 2004/0079547 A1
(43) Pub. Date: Apr. 29, 2004

(54) Wire and cable insulation

(76) Inventors: Giles Henry Rodway, Wiltshire (GB); Stuart Charles Steadman, Wiltshire (GB)

Correspondence Address: MYERS BIGEL SIBLEY & SAJOVEC, PO BOX 37428, RALEIGH, NC, 27627, US

(21) Appl. No.: 10/469,565

(22) PCT Filed: Feb. 22, 2002
(86) PCT No.: PCT/GB02/00781

(30) Foreign Application Priority Data
Mar. 14, 2001 (GB) 0106739.6
Jun. 15, 2001 (GB) 0114611.7

(51) Int. Cl. H01B 3/00

(52) U.S. Cl. 174/110 PM

(57) ABSTRACT

Wire or cable insulation comprising at least 30%, preferably at least 40%, of polypropylene homo- and/or co-polymer, and comprising at least 2%, preferably at least 4% zinc sulphide and/or at least 5%, preferably at least 10%, zinc oxide, percentages being by weight based on the whole insulation composition. preferably, the insulation contains little or substantially zero hydrated flame-retardant fillers and substantially zero mercaptobenzimidazole, and a majority by weight or substantially all of any propylene copolymers present are copolymers of propylene with halogen-free co-monomers.

This invention relates to electrical wire or cable insulation in which the insulating material consists of a polymeric portion which is predominantly polypropylene or a propylene containing copolymer, plus additional stabilisers, fillers and other additives, which give the formulation an unexpectedly advantageous balance of properties.

It has long been a goal of the wire and cable industry to produce a viable high performance insulation based on polypropylene. Such a formulation would be particularly useful in, for example, the automotive industry where the inherent toughness, low cost and recyclability of polypropylene are highly desirable characteristics. An additional strong driving force for this change is the desire to eliminate PVC for environmental reasons. Despite the increasing adoption of polypropylene in applications such as mouldings etc, however, it has not hitherto achieved widespread use as an automotive wire insulation, due to some critical limitations. Principally, these have been: (i) attack of polypropylene by degradation products of PVC, (ii) attack of polypropylene by fluids used in the automotive environment, (iii) extraction of antioxidants from the polypropylene by other materials in direct contact with it, particularly polymeric materials used in wiring harness manufacture, and (iv) insufficient thermal stability for long term service at high temperatures.

The capability to overcome these drawbacks would allow the widespread adoption of polypropylene as a wire in automotive wiring harnesses, particularly in the engine bay, where exposure to high temperatures for considerable periods of time (e.g. the widely recognised “class 3” requirement to survive 3000 hours at 125° C.), together with exposure to engine oil, windscreen washer fluid and other aggressive fluids are commonplace. In addition, it is essential for such applications that the wire be able to withstand contact with all common types of tape (adhesive and non adhesive), tubing, connectors, seals, and alternative cable jacket materials, as it is not economic to mass produce wiring harnesses which avoid the use of these components

In the present invention, the limitations of polypropylene with respect to the above requirements have been ameliorated, yielding an insulation with a highly advantageous balance of properties. Surprisingly, this is achieved by additions of relatively high levels of certain inorganic materials, in addition to conventional antioxidants. These additives are metal sulphides and/or oxides, especially zinc sulphide and/or oxide. Other potentially cost-effective metals whose sulphides and/or oxides may be useful according to the present invention include magnesium, calcium, iron, aluminium, and tin.

The sulphide and/or oxide additives are present at addition levels greater than 1%, preferably at least 2%, very preferably at least 4%, by weight in the total formulation. In particular, the metal sulphides, preferably zinc sulphide, are present at levels of at least 2%, preferably at least 4%, by weight and/or the metal oxides, preferably zinc oxide, are present at levels of at least 5%, preferably at least 10%, by weight. All percentage compositions stated herein are by weight based on the whole insulation composition. The rest of the formulation should consist of polypropylene homopolymer or preferably a copolymer containing propylene as one of the comonomers, together with other polymers as required, conventional antioxidants, stabilisers and process aids, flame retardants (either halogenated or halogen-free) and other fillers to obtain the required balance of properties.

The polypropylene (homo- and/or co-polymer) alone, or a mixture thereof with other polymers if present, preferably constitutes at least 30%, more preferably at least 40%, and often at least 50%, by weight of the whole insulation composition. In low-halogen or zero-halogen formulations, where relatively high levels of flame-retardant hydrated fillers such as aluminium or magnesium hydroxide may used, the polypropylene polymer or mixture preferably constitutes at least 30%, for example 30-50%, although higher polymer content may be achievable. In halogenated formulations where less or no hydrated fillers are used, the aforementioned polymer(s) preferably constitutes at least 40%, more preferably at least 50%, and often higher proportions of the insulation composition.

Preferred formulations contain little or substantially zero hydrated flame-retardant fillers and substantially zero mercaptobenzimidazole and a majority by weight or substantially all of any propylene copolymers present are copolymers of propylene with halogen-free co-monomers.

A further advantage found within the scope of the present invention is that the addition of the metal sulphide, in particular zinc sulphide, reduces or eliminates the need for a conventional metal (copper) deactivator. It is also observed that the incorporation of the metal sulphide reduces or eliminates the need for added antioxidant. Advantageous performance is obtained with additions of the metal sulphide alone or the metal oxide alone to insulation formulations of the above types, and further advantage may be obtained by a combination of the metal sulphide and oxide in the same formulation, each preferably at the levels suggested above.

Specific insulation formulations according to this invention are described below by way of non-limiting example.

### EXAMPLE A

This formulation contains a commercially available polypropylene (ethylene propylene copolymer) with 5% metal sulphide, 6% antioxidant package comprising a primary and a secondary antioxidant, and a halogen-containing flame retardant package at 21% by weight whereby the bromine content of the composition is about (not greater than) 13%. The compound can be mixed using conventional processing equipment such as a twin screw or internal mixing compounder. The compound can then be extruded onto a range of bare copper conductors at relatively low wall thickness e.g. 0.2 mm-0.3 mm.

The samples undergo accelerated ageing for 240 hours at 150° C. in contact with a range of PVC tapes typically used in general wire and cable harness applications. When no zinc sulphide is added to the formulation the samples (allowed to cool after removal from the heat ageing environment) crack on flexing around a mandrel of diameter approximately equal to four times the insulated wire diameter. The addition of the zinc sulphide at levels of 5% or more increases the compatibility with the PVC allowing approximately 600 hours ageing at 150° C. (in some cases more than 720 hours) before the insulation cracks on such bending.

Similar tests conducted in contact with known PVC sleeving at 125° C. show that with no zinc sulphide the samples will crack close to the PVC-polypropylene interface at approximately 1500-2000 hours heat ageing (sooner, if the quantity of antioxidant is reduced below 6%). Samples containing the zinc sulphide mixture show no cracks after 125° C. ageing for more than 3500 hours, indicating that the zinc sulphide tends to double the lifetime of wires exposed to PVC.

Data also shows that this pattern of improvement in heat ageing tends to be repeated when the zinc sulphide-containing polypropylene wires are in close contact with other harness components e.g. polymeric tubings, adhesives, polymeric and metallic connectors, cable ties and crimps.

### EXAMPLE B

This formulation contains a polypropylene copolymer with 20% zinc oxide and 6% antioxidant package as above, plus a halogen-containing flame retardant package present at 21% by weight.

Samples undergoing accelerated ageing for 240 hours at 150° C. in contact with PVC tapes show a similar improvement in PVC compatibility/heat ageing as in Example A above. The zinc oxide also gives an improved performance in contact with PVC sleeving at 125° C., although apparently not as efficient as the zinc sulphide, since the zinc oxide-containing samples show cracks at the PVC interface after 3000 hours.

### EXAMPLE C

Blends of polypropylene with EPR (Ethylene Propylene Rubber) were tested at polypropylene levels between 40% and 70% with EPR levels between 10% and 30%. Similar blends of polypropylene with VAE (vinyl acetate/ethylene copolymer) have also been trialed. Results show similar improvements for formulations containing zinc sulphide and/or zinc oxide at the above levels.

### EXAMPLE D

Formulations were tested containing the materials in Example A above with various levels of antioxidant and various ratios of primary to secondary antioxidant. Results indicate that the level of primary antioxidant should preferably be equal to or greater than 2%, although 4% or more is desirable, dependent on the level of secondary antioxidant present. The level of secondary antioxidant in these cases can be reduced to 2% without affecting results in compounds containing 5% zinc sulphide. Suitable primary and secondary antioxidants are known per se.

1. Wire or cable insulation comprising at least 30%, preferably at least 40%, of polypropylene homo- and/or co-polymer, and comprising at least 2%, preferably at least 4% zinc sulphide and/or at least 5%, preferably at least 10%, zinc oxide, percentages being by weight based on the whole insulation composition.

2. Insulation according to claim 1 containing little or substantially zero hydrated flame-retardant fillers and substantially zero mercaptobenzimidazole and wherein a majority by weight or substantially all of any propylene copolymers present are copolymers of propylene with halogen-free co-monomers.

3. Insulation according to claim 1 or 2, wherein the content of zinc sulphide and/or oxide is sufficient to increase by at least 25% (preferably at least 50%, more preferably at least 75%) the heat ageing time which the insulation, on a wire in contact with PVC tape or PVC sleeving, can tolerate without cracking on flexing after cooling to room temperature.

4. Insulation according to any preceding claim, which has low or substantially zero halogen content and comprises the polypropylene polymer or mixture at a level of at least 30%, preferably 30-50% by weight; or which has significant halogen content and comprises the polypropylene polymer or mixture at a level of at least 40%, preferably at least 50%.

5. Insulation according to any preceding claim, comprising at least 2%, preferably at least 4%, more preferably at least 6%, of an antioxidant package.

6. Insulation according to any preceding claim containing a polypropylene copolymer with 10-30% zinc oxide.

7. Insulation according to any preceding claim containing a mixture of zinc oxide and zinc sulphide.

8. Insulation according to any preceding claim containing a blend of polypropylene copolymer and one or more polymeric components, preferably ethylene propylene rubber, or VAE.

9. Insulation according to any preceding claim, wherein the antioxidant level is greater than 2%.

10. Insulation according to any preceding claim, wherein the antioxidant comprises primary and secondary antioxidants in a ratio within the range from 1:0 to 1:10, preferably 1:1 to 1:4.

11. Insulation according to claim 10 comprising zinc sulphide, wherein the antioxidant level is more than 2% and the secondary antioxidant is omitted (0%).

12. Insulation according to any preceding claim containing zinc sulphide which contains no additional copper deactivator.

13. Insulation according to any preceding claim which contains less than 7% halogen, preferably being substantailly free from halogen, and comprises a zero halogen flame retardant in levels between 20% and 60%.

14. Insulation according to any preceding claim, wherein the polypropylene is or includes a homopolymer and/or a propylene/ethylene copolymer, preferably a block copolymer.

15. Wire or cable insulation comprising at least 30%, preferably at least 40%, by weight, based on the whole insulation composition, of polypropylene homo- and/or co-polymer, and comprising sufficient metal sulphide and/or oxide, preferably zinc sulphide and/or zinc oxide, to increase by at least 25% (preferably at least 50%, more preferably at least 75%) the heat ageing time which the insulation, on a wire in contact with PVC tape or PVC sleeving, can tolerate without cracking on flexing after cooling to room temperature.
